(19) United States
(12) Patent Application Publication
(10) Pub. No.: US 2026/0002848 A1
(43) Pub. Date: Jan. 1, 2026

(54) METHOD FOR PREPARING BIOLOGICAL, HISTOLOGICAL, AUTOPSICAL, CYTOLOGICAL SAMPLES AND COMPOSITION THEREFOR

(71) Applicant: IMBERG SPA, Martinengo (BG) (IT)

(72) Inventors: Carmelo Lupo, Martinengo (BG) (IT); Nadia Casatta, Martinengo (BG) (IT); Daria Gafforelli, Martinengo (BG) (IT); Alberto Battistel, Martinengo (BG) (IT); Vladimiro Bergamini, Martinengo (BG) (IT)

(73) Assignee: IMBERG SPA, Martinengo (BG) (IT)

(21) Appl. No.: 18/992,485

(22) PCT Filed: Jun. 30, 2023
(86) PCT No.: PCT/IB2023/056837

§ 371 Date: Jan. 8, 2025

(30) Foreign Application Priority Data
Jul. 12, 2022 (IT) 102022000014605

(51) Int. Cl. G01N 1/30; G01N 1/28

(52) U.S. Cl. CPC G01N 1/30; G01N 1/286; G01N 2001/305

(57) ABSTRACT

The present invention relates to a novel composition for preparing biological, cytological, histological and autopsical samples, in particular to a composition capable of merging reagents for the dehydration, clarification, and to its use in the preparation of samples for analysis.

### SUMMARY OF THE INVENTION

The present invention relates to a novel composition for preparing biological, cytological, histological and autopsical samples, in particular to a composition capable of merging reagents for the dehydration, clarification, and to its use in the preparation of samples for analysis.

### TECHNICAL BACKGROUND

As it is known, the analysis of biological samples, such as histological, autopsical, cytological and similar samples, is of fundamental importance in modern medicine, not only because it ensures accurate and early diagnosis of a number of diseases but also because it allows for complex studies that contribute to progress in the field. Of course, the samples to be analyzed must be handled and prepared according to precise protocols in order to ensure optimal preservation, reproducibility of analysis and reliability of results.

At present, in the case of a sample taken from an operated part or from a previously fixed post-mortem examination (e.g., a tissue sample), the preparation of the sample for the examination consists of a “processing” step designed to prepare the sample for embedding into a medium of appropriate consistency to impart the rigidity necessary for cutting by blades. To date, the embedding material that best meets these characteristics is paraffin, which is, however, a substance that cannot be mixed with most of the fixatives used. For this reason, in order for the tissue to be embedded in paraffin and then cut as needed, it must undergo several treatments, all inherent in the processing step, which can be summarized as follows:
a. dehydration step, in which the water in the sample is replaced by anhydrous reagents;
b. clarification step, in which the anhydrous reagent is replaced by a component (clarifying medium) that can be mixed both with the anhydrous reagent and the embedding medium;
c. impregnation step, in which the clarifying medium is replaced by the impregnation medium (or embedding medium).

Steps (a) and (b) are defined herein as the “processing” of the sample.

The first step provides for the removal of the aqueous reagents used in the initial step to fix the freshly taken sample. A number of dehydrating agents can be used but preferably ethyl alcohol is used in increasing concentrations, that is, the sample is first treated with 70% ethyl alcohol, then with 95% ethyl alcohol and then again with 100% ethyl alcohol. Because the most commonly used dehydrating agents are not soluble in paraffin (the medium in which the sample is to be embedded), they must be replaced by a component that is soluble in both the dehydrating agent and the impregnation agent. Commonly used in this step is xylene (or xylol, dimethylbenzene), which is an aromatic hydrocarbon constituted by a mixture of ortho, meta and para isomers, in flammable, highly volatile and potentially highly toxic liquid form. The potential toxicity of xylene is a constant concern for users. The non-specific effect on the central nervous system initially manifests with nausea and gastrointestinal problems and, if intoxication persists, dizziness, stupor and vomiting. Inhalation causes irritation of the respiratory mucous membranes and probable pulmonary edema. Alterations in the central nervous system, leukocyte formula, cardiac function and, most importantly, potential carcinogenicity have been observed in the case of chronic xylene exposure.

Still according to the known art, the processing step is generally followed by a paraffin embedding step, a cutting step and a staining step. The latter provides for removing the paraffin (which was used only as a cutting backing) by treatment with xylene, a rehydration step with alcohols of varying titers (100%, 95%, 70%), staining of the sample, another dehydration step (70%, 95%, 100%) and, finally, further treatment with xylene to remove the dehydrating agent allowing slide mounting.

Even in the case of analysis of cytological samples, where paraffin embedding is not planned or necessary, the repeated use of xylene is required because, even in these cases, the sample undergoes a number of hydration and dehydration steps. It is therefore apparent that the repeated use of xylene within a sequence to prepare biological, histological and/or autopsical samples for examination poses some risk to the operator, even in cases where most of the sequences are done by an automated system.

Studies have been carried out to find alternatives to xylene.

WO03/100384, in the name of the same Applicant, describes alternative compositions that avoid the use of xylene, which comprise aliphatic hydrocarbons and alcohols, preferably octane, ethyl alcohol and isopropyl alcohol. These compositions, although effective on most samples, do not provide optimal results in processing samples having an adipose component.

The Applicant noted that most of the known compositions, including those described in WO03/100384, are not suitable for processing samples of adipose tissues, and that even the compositions in the Italian Patent Applications mentioned above, although very effective in processing most tissues. In fact, tissues with an adipose component, for example but not only, breast tissue, are tissues that are known to be more difficult to process than other tissues, require longer processing times and are less responsive to dehydration, clarification and infiltration treatments.

For completeness, the following table shows the comparison between a standard processing protocol and that of fat tissue processing by an automatic processor with alcohols and xylene. Both protocols exemplify procedures used routinely in anatomic pathology laboratories.

| | | STANDARD | FAT |
|---|---|---|---|
| | | SAMPLE | SAMPLE |
| REAGENT | TEMPERATURE | TIME (hours) | TIME (hours) |
| Formalin | ambient | 1:30 | 1:30 |
| Alcohol | ambient | 0:15 | 0:15 |
| Alcohol | ambient | 1:00 | 1:00 |
| Alcohol | ambient | 1:00 | 1:00 |
| Alcohol | ambient | 1:00 | 1:00 |
| Alcohol | ambient | 1:00 | 1:00 |
| Alcohol | ambient | 1:45 | 1:45 |
| Alcohol | ambient | 2:00 | 2:45 |
| Xylene | 35° C. | 1:00 | 1:00 |
| Xylene | 35° C. | 1:30 | 2:00 |
| Xylene | 35° C. | 2:00 | 3:30 |
| Paraffin | 60° C. | 1:00 | 1:00 |
| Paraffin | 60° C. | 1:30 | 1:30 |
| Paraffin | 60° C. | 2:00 | 2:30 |

| | | |
|---|---|---|
| Total time | 18:44 | 21:59 |

The above processing is frequently used for treating samples with suspected oncological nature. In such area, it is known that a high percentage of samples have a significant adipose component, which by its inherent nature, requires prolonged treatments to achieve optimal processing. To give an idea of the extent of the spread of what is described, FIG. 1, taken from the site https://gco.iarc.fr/today/home, which collects official WHO data, is depicted. From FIG. 1, it turns out that breast cancer clearly shows with higher incidence but the incidence of, for example, colorectal cancer, another tissue with an important adipose component, is also relevant. The Applicant noted that most of the known compositions are not suitable for processing tissue samples with adipose component, and that even the compositions in the Italian Patent Applications mentioned above, although very effective in processing most tissues, do not provide optimal results on tissues with a predominance of adipose component.

In light of the above data, it seems evident that there is an actual need to provide novel innovative reagents that can also more effectively process the samples having a fat component, thus allowing to save time and solvents, making the processing of samples for analysis faster, cheaper and safer.

CN108344608 D1 describes the microwave processing of biological samples by three sequential treatments with three different reagent mixtures A, B, and C. In particular, the C mixture comprises an isoparaffin that is constituted by isododecane, a long-chain hydrocarbon that is constituted by n-heptane, and further comprises n-hexanol and methylsalicylate.

CN108387421 describes the microwave processing of biological samples by two sequential treatments with two reagent mixtures A and B. In particular, the B mixture comprises an isoparaffin that is constituted by isododecane, a long-chain hydrocarbon that is constituted by n-heptane, and further comprises n-hexanol.

In both of the above documents, no single composition is described for processing biological samples but three mixtures (A, B and C) or two mixtures (A and B) are used sequentially.

### OBJECTS OF THE INVENTION

An object of the present invention is to provide a composition for processing biological, histological, autopsical, cytological and similar samples that is non-carcinogenic, has a low level of toxicity, is quick and easy to apply and can also be used effectively for processing samples with an adipose component.

Another object of the invention is to provide the use of said composition for processing biological, cytological, histological and autopsical samples for the analysis thereof, and a method for processing said samples.

A further object is to provide a composition as a single reagent for performing the simultaneous dehydration and clarification of biological, cytological, histological and autopsical samples, also for tissues with an adipose component.

Finally, a further object of the invention is to provide methods and processes which use said composition.

### BRIEF DESCRIPTION OF THE FIGURES

FIGS. 1 and 2 show the worldwide incidence of different cancer diseases classified by originating tissue; in FIG. 1 the data include both sexes and all age groups, in FIG. 2 the data include only female sex and all age groups.

FIG. 3 shows in detail the morphology of adipose tissue and intestinal mucosa samples processed with Formulation 1 and the morphology of samples processed with Formulation 1 (first two strips) compared with a formulation of WO03/100384 (Comparative Formulation 1, last two strips).

FIG. 4 shows in detail the morphology of adipose tissue and intestinal mucosa samples processed with Formulation 2 and the morphology of samples processed with Formulation 2 (first two strips) compared with a formulation of WO03/100384 (Comparative Formulation 1, last two strips).

FIG. 5 shows in detail the morphology of adipose tissue and intestinal mucosa samples processed with Formulation 3 and the morphology of samples processed with Formulation 3 (first two strips) compared with a formulation of WO03/100384 (Comparative Formulation 1, last two strips).

FIG. 6 shows in detail the morphology of adipose tissue and intestinal mucosa samples processed with Comparative Formulation 2.

FIG. 7 shows in detail the morphology of adipose tissue and intestinal mucosa samples processed with Comparative Formulation 3.

FIG. 8 shows in detail the morphology of adipose tissue and intestinal mucosa samples processed with Comparative Formulation 4.

FIG. 9 shows in detail the morphology of adipose tissue and intestinal mucosa samples processed with Comparative Formulation 5.

FIG. 10 shows in detail the morphology of adipose tissue and intestinal mucosa samples processed with Comparative Formulation 6.

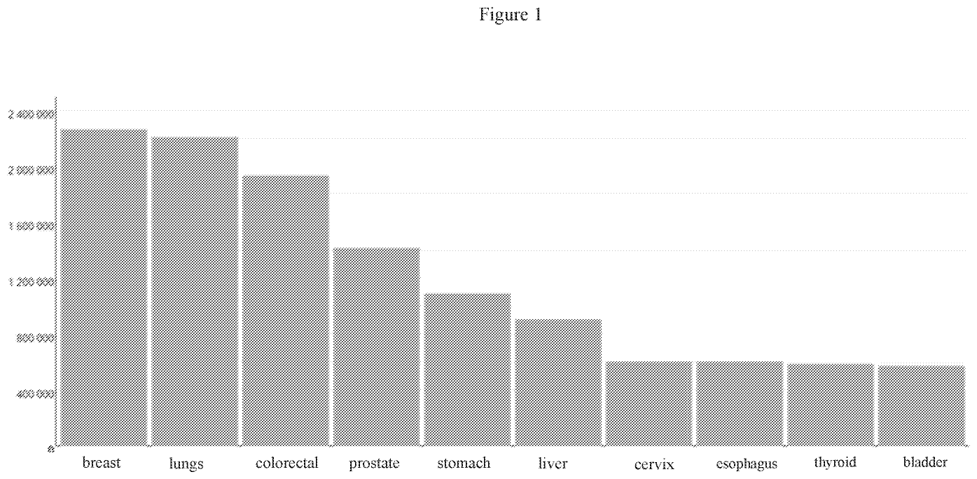

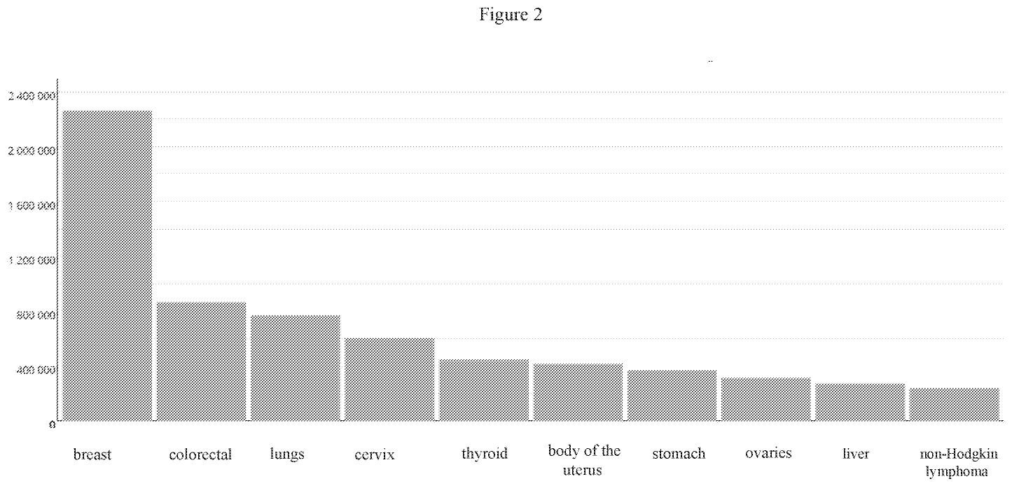

In all cases, after processing, the samples were embedded, cut, stained, mounted and viewed under a microscope.

### DESCRIPTION OF THE INVENTION

Subject-matter of the invention, according to an aspect thereof, is the use of a composition comprising isoparaffin, at least one alcohol having 5 or 6 carbon atoms and possibly at least one alcohol selected from ethanol and isopropanol, for processing biological, cytological, histological and autopsical samples for the analysis thereof.

More particularly, object of the invention is the use of said composition as a reagent for the simultaneous “processing” of the sample before its infiltration in paraffin, i.e. the dehydration and clarification treatments.

According to a preferred embodiment, said samples include tissue samples with an adipose component.

By “tissue with an adipose component” is meant herein to denote any tissue rich in fat matter, such as adipocytes, lipomas, parenchymal tissue, breast tissue, omentum, skin, and the like.

According to the invention, the at least one alcohol having 5 or 6 carbon atoms can be linear or branched such as n-pentanol, iso-pentanol, 2-methylbutanol, n-hexanol, neo-hexanol, iso-hexanol, 3-methylpentanol, 2,3-dimethylbutanol. Mixtures of alcohols having 5 or 6 carbon atoms can also be used. According to a preferred embodiment, said alcohol is selected from 2-methylbutanol, n-hexanol and mixtures thereof. Iso-pentanol also provided optimal results and thus could be used but unfortunately has a very unpleasant odor, so it is not among the alcohols which are preferable according to the invention.

By “isoparaffin” is meant herein to denote a mixture of aliphatic hydrocarbons, preferably a mixture of aliphatic hydrocarbons predominantly composed of molecules having 9 to 28 carbon atoms, predominantly 11 to 15 carbon atoms.

Preferably, by “isoparaffin” is meant herein to denote a mixture of aliphatic hydrocarbons, substantially free of aromatic hydrocarbons (usually less than 2%) with a melting point below 60° C. and predominantly composed of molecules having 9 to 28 carbon atoms, predominantly 11 to 15 carbon atoms. According to a preferred embodiment, the isoparaffin of the composition of the invention has Chemical Abstracts number 90622-58-5 (defined as “Alkanes, C11-15-iso-” according to ECHA (European Chemicals Agency).

According to the present invention, isoparaffin is a mixture of aliphatic hydrocarbons, as defined above, and is not constituted by isododecane alone.

Compared with the clarifiers commonly used in anatomic pathology, isoparaffin is a particularly advantageous hydrocarbon because, in addition to providing optimal results in the composition of the invention, it is not categorized as either GHS02 or GHS09 under the Globally Harmonized System (GHS) labeling.

Unless otherwise specified, all percentages and ratios described herein are expressed by volume. It is understood that the total percentage of components is referred to 100, considering the entire composition.

According to a preferred embodiment for use according to the invention, the composition also comprises at least one alcohol selected from ethanol and isopropanol, more preferably both alcohols.

Subject-matter of the invention, according to such preferred embodiment, is the use of a composition comprising isoparaffin, at least one alcohol having 5 or 6 carbon atoms, ethanol and isopropanol, for processing biological, cytological, histological and autopsical samples for the analysis thereof.

Subject-matter of the present invention, according to another aspect thereof, is a composition comprising, or alternatively consisting of, isoparaffin, at least one alcohol having 5 or 6 carbon atoms, and possibly at least one alcohol selected from ethanol and isopropanol, preferably both alcohols.

According to a preferred embodiment, the composition of the invention comprises, or alternatively consists of:
isoparaffin: 40-80%, preferably about 60%;
at least one alcohol having 5 or 6 carbon atoms: 20-60%, preferably 20-40%, more preferably about 20%;
ethanol: 0-15%, preferably about 10%; and
isopropanol: 0-15%, preferably about 10%;
possibly one or more further components, at the rate of 0-15%, preferably 0-5%;

said % being expressed by volume to the total volume of the composition.

The aforementioned preferred embodiments also apply to the composition for use according to the invention described above.

According to a preferred embodiment, the composition of the invention comprises or in alternative consists of 60% isoparaffin, 20% at least one alcohol having 5 or 6 carbon atoms, preferably 2-methyl-butanol, n-hexanol or the mixtures thereof, 10% ethanol and 10% isopropanol.

According to another of its aspects, subject-matter of the invention is a process for preparing biological, histological, autopsical and cytological samples for the examination thereof, which comprises treating said samples with the composition according to the invention.

According to another of its aspects, subject-matter of the invention is a method for the examination of biological, histological, autopsical and cytological samples that comprises processing said samples with the composition according to the invention.

According to another of its aspects, subject-matter of the invention are biological, histological, autopsical and cytological samples for examination, which are prepared by using the composition according to the invention.

The composition of the invention allows the sample dehydration and clarification to be carried out without requiring the use of any additional equipment and without having to apply to the treated sample above particular temperature and/or pressure conditions. In fact, at the above concentrations, the composition according to the invention can be used at room temperature and pressure and provides perfectly processable samples, resulting in high reliability of results and remarkable convenience and ease of use. Because no additional equipment is involved, the steps are easy to implement and even an unskilled operator can easily and successfully perform sample processing for analysis.

A process for preparing the composition according to the invention provides for mixing the components until completely mixed.

The composition according to the present invention advantageously finds use in the preparation of biological, histological, autopsical, cytological and similar samples, even when they have a major adipose component, as defined above.

The dehydration and clarification steps are performed at ambient pressure and temperature without the need for any additional treatment, so they can be easily performed in any working environment and by operators who are not particularly skilled. Furthermore, since no special temperatures and pressures need to be applied, the risk of error is reduced and the result is more reliable.

Thus, the composition according to the present invention allows dehydration and clarification with a single component, at room temperature and pressure. This way, the processing step can be carried out in fewer steps by using a non-toxic and non-carcinogenic substance, as opposed to the xylene that is required in the process according to the known art.

Still with reference to the procedure for preparing biological, histological and autopsical samples for examination, as already mentioned, after processing with the composition of the invention, the sample is ready to be placed in a backing that allows it to be cut into sections suitable for examination. The most commonly used embedding medium is paraffin, both because it is inexpensive and because it can be easily manipulated and very fine tissue sections can be obtained.

In addition to the above, the composition according to the invention can also be used in any histological staining protocol that requires intermediate stages in alcohols at different percentages alongside any xylene treatment, sometimes maintaining the same stage duration but providing a marked improvement in the manual aspect of the method and ease of execution.

The invention is illustrated in more detail in the Experimental Section below, by way of example only and in no way limiting.

### EXPERIMENTAL SECTION

### Examples

Tests were carried out on 5 mm-thick samples of adipose and non-adipose tissue, which were processed with the formulations according to the set forth protocols.

All the tests have been carried out at ambient pressure and temperature.

Water is distilled water.

The % are expressed by volume to the total volume of the composition.

After infiltration was finished, the samples were embedded, cut, stained, mounted, viewed under a microscope, and the qualities of morphology were compared with specular samples treated with compositions not according to the invention.

### Example 1

### Formulation 1 (According to the Invention)

60% isoparaffin
20% 2-methyl-1-butanol
10% ethanol
10% isopropanol

### Conditions:

| REAGENT | TIME |
|---|---|
| Water | 10′ |
| 99% Ethanol | 30′ |
| 99% Ethanol | 60′ |
| Formulation 1 | 60′ |
| Formulation 1 | 60′ |
| Formulation 1 | 1 h 30′ |
| Formulation 1 | 2 h |
| Paraffin | 4 h |

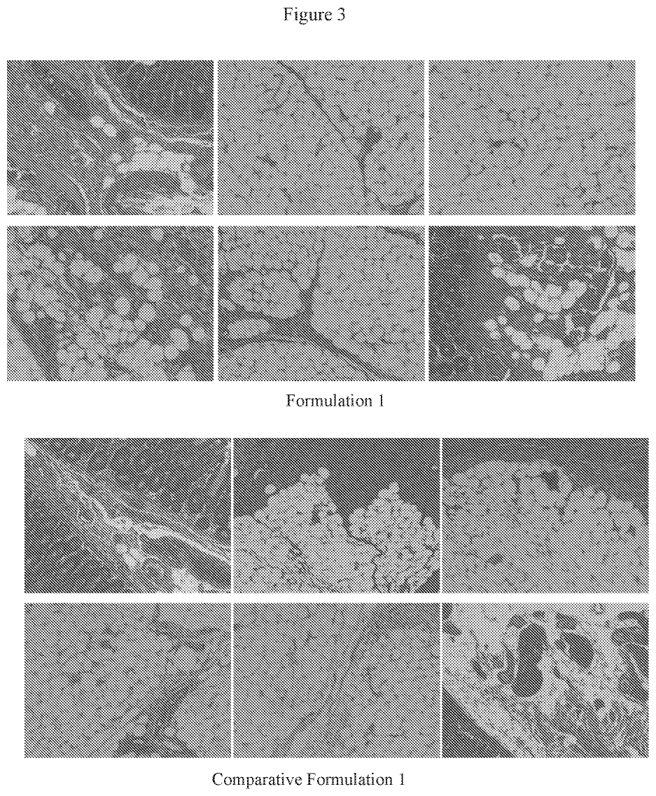

Details of the samples are provided in FIG. 3 (Formulation 1 up, Comparative Formulation 1 down, under the same conditions).

### Formulation 2 (According to the Invention)

60% isoparaffin
20% n-hexanol
10% ethanol
10% isopropanol

### Conditions:

| REAGENT | TIME |
|---|---|
| Water | 10′ |
| 99% Ethanol | 30′ |
| 99% Ethanol | 30′ |
| Formulation 2 | 60′ |
| Formulation 2 | 60′ |
| Formulation 2 | 1 h 30′ |
| Formulation 2 | 2 h |
| Paraffin | 4 h |

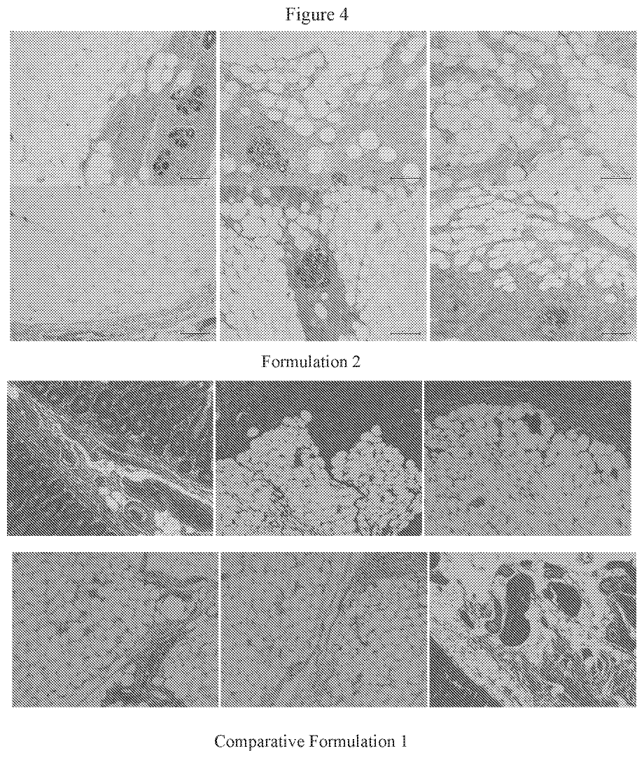

Details of the samples are provided in FIG. 4 (Formulation 2 up, Comparative Formulation 1 down, under the same conditions).

### Formulation 3 (According to the Invention)

60% isoparaffin
40% 2-methyl-1-butanol

### Conditions:

| REAGENT | TIME |
|---|---|
| Water | 10′ |
| 99% Ethanol | 30′ |
| 99% Ethanol | 60′ |
| Formulation 3 | 60′ |
| Formulation 3 | 60′ |
| Formulation 3 | 1 h 30′ |
| Formulation 3 | 2 h |
| Paraffin | 4 h |

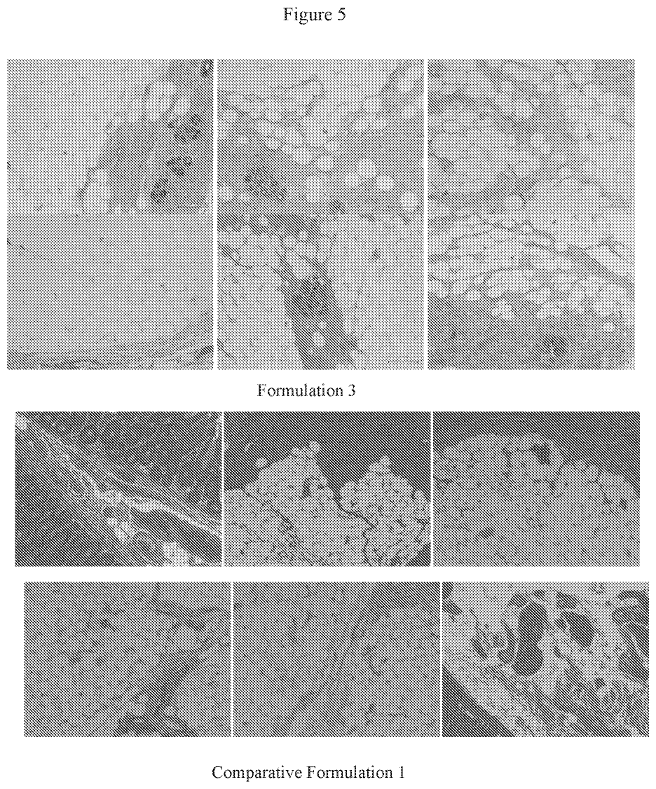

Details of the samples are provided in FIG. 5 (Formulation 3 up, Comparative Formulation 1 down, under the same conditions).

### Example 2

Some comparative formulations, not containing alcohols having 5 or 6 carbon atoms (Comparative Formulation 2) and containing atoms having 4 or 7 carbon atoms (Comparative Formulations 3 to 6), were prepared and tested.

### Comparative Formulation 1 (not According to the Invention)

60% Exxsol
20% ethanol
20% isopropanol

### Comparative Formulation 2 (not According to the Invention)

60% isoparaffin
20% ethanol
20% isopropanol

### Conditions

| REAGENT | TIME |
|---|---|
| Water | 10′ |
| 99% Ethanol | 30′ |
| 99% Ethanol | 60′ |
| Comp Form 1 | 60′ |
| Comp Form 1 | 60′ |
| Comp Form 1 | 1 h 30′ |
| Comp Form 1 | 2 h |
| Paraffin | 4 h |

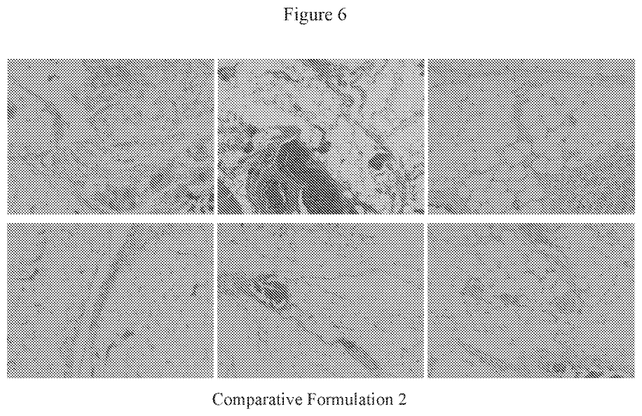

Details of the samples are provided in FIG. 6.

### Comparative Formulation 3 (not According to the Invention)

60% isoparaffin
20% tert-butanol
10% ethanol
10% isopropanol

### Conditions

| REAGENT | TIME |
|---|---|
| Water | 10′ |
| 99% Ethanol | 30′ |
| 99% Ethanol | 60′ |
| Comp Form 2 | 60′ |
| Comp Form 2 | 60′ |
| Comp Form 2 | 1 h 30′ |
| Comp Form 2 | 2 h |
| Paraffin | 4 h |

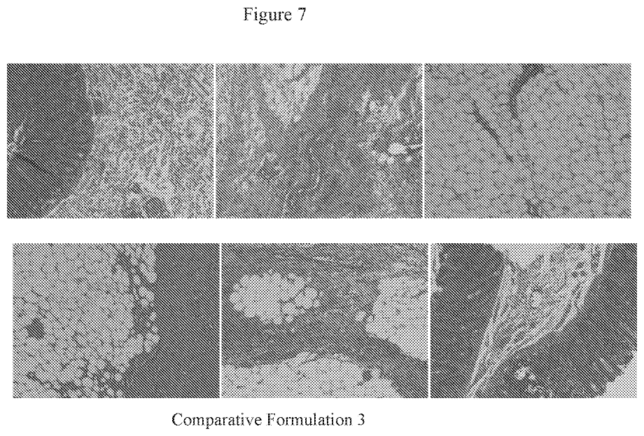

Details of the samples are provided in FIG. 7.

### Comparative Formulation 4 (not According to the Invention)

60% isoparaffin
20% n-heptanol
10% ethanol
10% isopropanol

### Conditions

| REAGENT | TIME |
|---|---|
| Water | 10′ |
| 99% Ethanol | 30′ |
| 99% Ethanol | 60′ |
| Comp Form 3 | 60′ |
| Comp Form 3 | 60′ |
| Comp Form 3 | 1 h 30′ |
| Comp Form 3 | 2 h |
| Paraffin | 4 h |

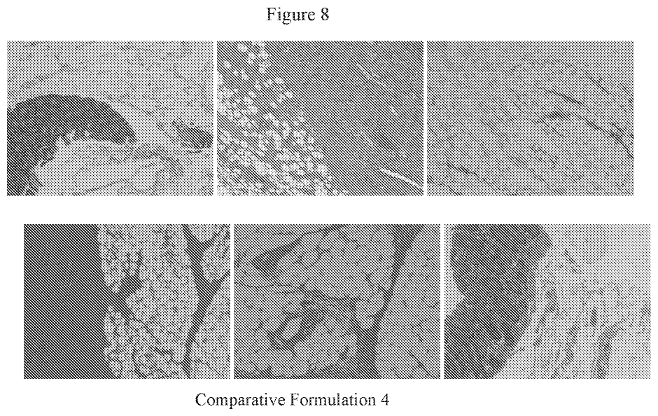

Details of the samples are provided in FIG. 8.

### Comparative Formulation 5 (not According to the Invention)

60% isoparaffin
40% tert-butanol

### Conditions

| REAGENT | TIME |
|---|---|
| Water | 10′ |
| 99% Ethanol | 30′ |
| 99% Ethanol | 60′ |
| Comp Form 4 | 60′ |
| Comp Form 4 | 60′ |
| Comp Form 4 | 1 h 30′ |
| Comp Form 4 | 2 h |
| Paraffin | 4 h |

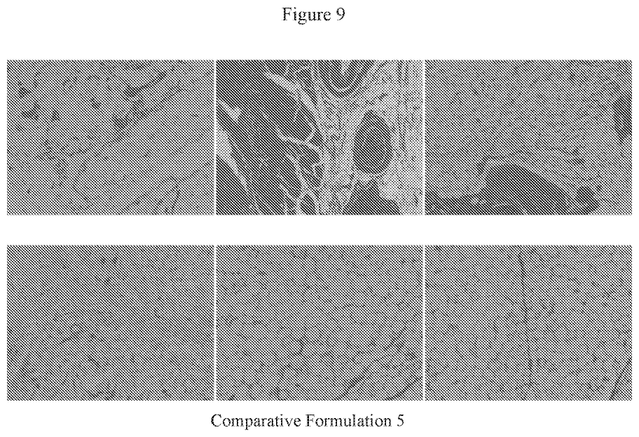

Details of the samples are provided in FIG. 9.

### Comparative Formulation 6 (not According to the Invention)

60% isoparaffin
40% n-heptanol

### Conditions

| REAGENT | TIME |
|---|---|
| Water | 10′ |
| 99% Ethanol | 30′ |
| 99% Ethanol | 60′ |
| Comp Form 5 | 60′ |
| Comp Form 5 | 60′ |
| Comp Form 5 | 1 h 30′ |
| Comp Form 5 | 2 h |
| Paraffin | 4 h |

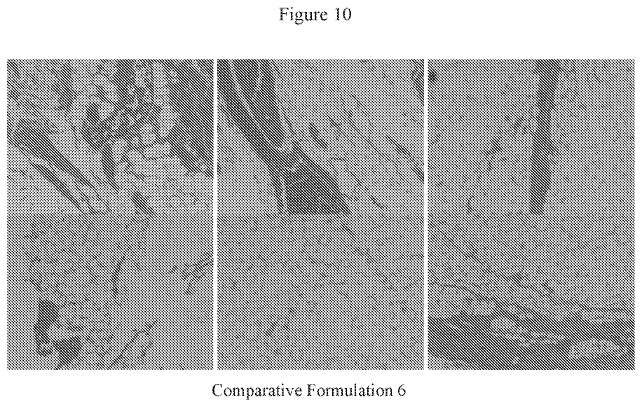

Details of the samples are provided in FIG. 10.

The analysis of the samples shows that Formulations 1 to 3, corresponding to compositions according to the invention, provide better results than the Comparative Formulations. In particular, Formulations 1 to 3 showed excellent effectiveness in processing samples, providing qualitatively better tissues than what provided by the Comparative Formulations and what can be achieved by processing similar samples according to standard state-of-the-art protocols.

In fact, as evident from the figures, the tissue portions with predominance of adipose component, if processed with the compositions not according to the invention, do not show optimal preservation of morphology. Adipocytes are not well stretched and the other tissue components fail to properly maintain their original structure. It is therefore more difficult for technicians to manage the sample in the post-processing steps and for pathologist to read the preparation.

1. A method for processing biological, cytological, histological ad autopsical samples for the analysis thereof, with a composition comprising isoparaffin, at least one alcohol having 5 or 6 carbon atoms and optionally at least one alcohol selected from ethanol and isopropanol, wherein said isoparaffin is a mixture of aliphatic hydrocarbons, said method comprising
treating said biological, cytological, histological and autopsical samples with said composition.

2. The method according to claim 1, wherein said isoparaffin is not constituted by isododecane alone.

3. The method according to claim 1, wherein said composition comprises isoparaffin, at least one alcohol having 5 or 6 carbon atoms, ethanol and isopropanol.

4. The method according to claim 1, wherein said at least one alcohol having 5 or 6 carbon atoms is selected from 1-methylbutanol, n-hexanol and mixtures thereof.

5. The method according to claim 1, wherein said composition comprises:
isoparaffin: 40-80%;
at least one alcohol having 5 or 6 carbon atoms: 20-60%;
ethanol: 0-15%;
optionally one or more further components, at the rate of 0-15%;
said % being expressed by volume to the total volume of the composition, wherein said isoparaffin is mixture of aliphatic hydrocarbons.

6. A composition comprising:
isoparaffin: 40-80%;
at least one alcohol having 5 or 6 carbon atoms: 20-60%, said at least one alcohol being selected from 2-methyl-butanol, n-hexanol and mixtures thereof;
ethanol 0-15%; and
isopropanol: 0-15%;
optionally one or more further components, at the rate of 0-15%;
said % being expressed by volume to the total volume of the composition, wherein said isoparaffin is mixture of aliphatic hydrocarbons.

7. The composition according to claim 6 comprising 60% isoparaffin, 20% at least one alcohol having 5 or 6 carbon atoms, comprising 2-methyl-butanol, n-hexanol or the mixtures thereof, 10% ethanol and 10% isopropanol.

8. The composition according to claim 7 comprising:
isoparaffin: 40-80%;
at least one alcohol having 5 or 6 carbon atoms: 20-60%;
optionally one or more further components, at the rate of 0-15%;
said % being expressed by volume to the total volume of the composition.

9.-10. (canceled)

11. A method for examining biological, histological, autopsical and cytological samples, comprising processing said samples with the composition according to claim 5.
